(19) United States
(12) Patent Application Publication
(10) Pub. No.: US 2013/0108083 A1
(43) Pub. Date: May 2, 2013

(54) AUDIO PROCESSING SYSTEM AND ADJUSTING METHOD FOR AUDIO SIGNAL BUFFER

(71) Applicants: Kai-Ju Cheng, Kuei Shan Hsiang (TW); Ying-Jie Wang, Kuei Shan Hsiang (TW); Kuo-Chun Huang, Kuei Shan Hsiang (TW); Chih-Wei Tuan, Kuei Shan Hsiang (TW)

(72) Inventors: Kai-Ju Cheng, Kuei Shan Hsiang (TW); Ying-Jie Wang, Kuei Shan Hsiang (TW); Kuo-Chun Huang, Kuei Shan Hsiang (TW); Chih-Wei Tuan, Kuei Shan Hsiang (TW)

(73) Assignee: QUANTA COMPUTER INC., Kuei Shan Hsiang (TW)

(21) Appl. No.: 13/616,992

(22) Filed: Sep. 14, 2012

(30) Foreign Application Priority Data
Nov. 2, 2011 (TW) 100139904

(51) Int. Cl. H04R 3/00

(52) U.S. Cl. 381/122

(57) ABSTRACT

An audio processing system is provided. The audio processing system has a sound receiving device configured to receive sounds and output an audio signal; a controller, electrically connected to the sound receiving unit, configured to write the audio signal to an audio signal buffer with a first frequency; and an audio processing unit, electrically connected to the controller, configured to read the audio signal from the audio signal buffer with a second frequency to perform audio processing, wherein the controller further dynamically adjusts the second frequency, so that the second frequency approaches the first frequency according to a convergence curve.

### CROSS REFERENCE TO RELATED APPLICATIONS

This Application claims priority of Taiwan Patent Application No. 100139904, filed on Nov. 2, 2011, the entirety of which is incorporated by reference herein.

### BACKGROUND OF THE INVENTION

1. Field of the Invention

The present invention relates to audio processing, and in particular relates to an audio processing system and audio signal buffer adjusting method, dynamically adjusting the writing frequency and reading frequency of audio signals in a universal serial bus (USB) audio device.

2. Description of the Related Art

In video conferencing, it is common to use a USB microphone to receive sounds, and the USB microphone writes the audio signals to the audio signal buffer through the USB interface for subsequent audio processing, however, the system reads the audio signals from the audio signal buffer through the inter-IC sound (I2S) interface. Due to hardware limitation, the operating frequencies of the USB interface and the I2S interface may not be identical, thereby causing data overrun or underflow in the audio signal buffer, and thus the continuity and accuracy of the retrieved audio signals might be affected.

### BRIEF SUMMARY OF THE INVENTION

A detailed description is given in the following embodiments with reference to the accompanying drawings.

In an exemplary embodiment, an audio processing system is provided. The audio processing system has a sound receiving device configured to receive sounds and output an audio signal; a controller, electrically connected to the sound receiving unit, configured to write the audio signal to an audio signal buffer with a first frequency; and an audio processing unit, electrically connected to the controller, configured to read the audio signal from the audio signal buffer with a second frequency to perform an audio processing, wherein the controller further dynamically adjusts the second frequency, so that the second frequency approaches the first frequency according to a convergence curve.

In another exemplary embodiment, an audio signal buffer adjusting method is provided. The method comprises the following steps of: receiving sounds and outputting an audio signal; writing the audio signal to an audio signal buffer with a first frequency; reading the audio signal from the audio signal buffer with a second frequency; and dynamically adjusting the second frequency, so that the second frequency approaches the first frequency according to a convergence curve.

### BRIEF DESCRIPTION OF THE DRAWINGS

The present invention can be more fully understood by reading the subsequent detailed description and examples with references made to the accompanying drawings, wherein:

FIG. 1 illustrates a block diagram of the audio processing system according to an embodiment of the invention.

FIGS. 2A˜2E illustrate the procedure of the storage condition of the audio signal buffer 140 according to an embodiment of the invention.

FIG. 3 illustrates a diagram of the convergence curve according to an embodiment of the invention.

FIG. 4 illustrates a flow chart of the audio signal buffer adjusting method according to an embodiment of the invention.

FIG. 5 illustrates a flow chart of the audio signal buffer adjusting method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

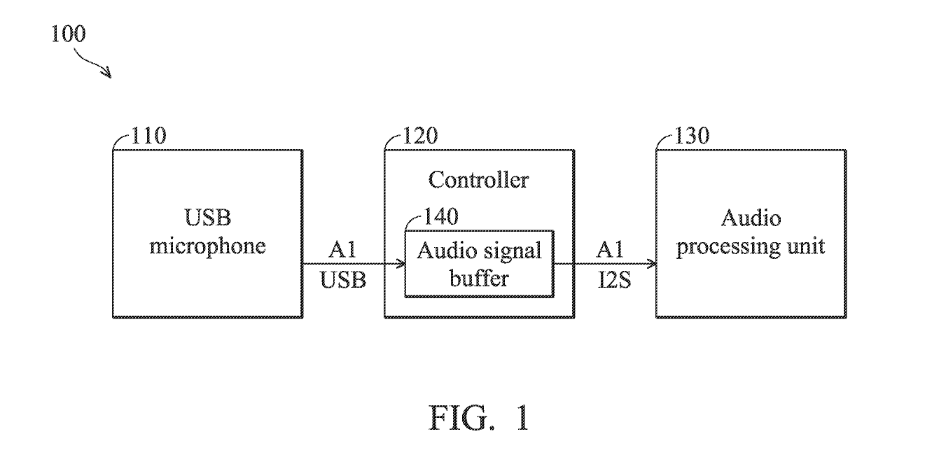

FIG. 1 illustrates a block diagram of the audio processing system according to an embodiment of the invention. The audio processing system 100, for example, is applied in a video conferencing system. The audio processing system 100 may comprise a sound receiving device 110, a controller 120 and an audio processing unit 130. For example, the sound receiving device 110 can be a USB microphone 110 equipped with a first transmission interface, such as a USB interface. The USB microphone 110 is configured to receive sounds and output an audio signal A1, wherein the audio signal A1 is sampled with a frequency of 48 KHz (not limited) and a data width of 16 bits, and transmitted to the controller 120 through the USB interface. The controller 120 is configured to receive the audio signal A1 from the USB microphone 110, and store the received audio signal A1 in an audio signal buffer 140 of the controller 120. The audio signal buffer 140, for example, can be a dynamic access memory (e.g. SRAM, DRAM), or a first-in-first-out (FIFO) register. The controller 120 can be a central processing unit (CPU), a digital signal processing unit (DSP) or other equivalent circuits capable of executing the same functions. The audio processing 130 may read the audio signal A1 from the audio signal buffer 140 through a second transmission interface, such as an I2S interface, to perform audio processing.

It should be noted that the frequency used in the USB microphone 110 can be 48 KHz, 44.1 KHz, 32 KHz, or 16 KHz generally, in which the USB microphone 110 may use one of them as fixed writing frequency f1 (i.e. depending on the device and being unchangeable) to write the audio signal A1 into the audio signal buffer 140 of the controller 120 through the USB interface. However, due to hardware limitations (e.g. the oscillator), a difference between the writing frequency f1 and the reading frequency f2 (i.e. reading the audio signal A1 from the audio signal buffer 140 through the I2S interface by the audio processing unit 130) may be caused, which leading to data overrun or underflow of the audio signal A1 stored in the audio signal buffer 140. In the application, the controller 120 may detect the storage condition of the audio signal buffer 140, such as data overrun, data underrun, whether the data overrun threshold has been reached, or whether the data underrun threshold has been reached, etc., and the controller 120 may adjust the reading frequency f2 of the I2S interface of the audio processing unit 130 according to the storage condition. Generally, when the USB microphone and the controller 120 is electrically connected, the controller 120 may determine the writing frequency f1 of the USB microphone 110, and set the reading frequency f2 according to the determined operating frequency (the details will be described later).

It is noted that the first transmission interface is not limited to the USB interface, and the second transmission interface is not limited to the I2S interface. Microphones with other transmission interfaces other than the USB and I2S interface can be used. The technical feature of the application can be applied to different interfaces or the same interfaces with the different writing frequency f1 and reading frequency f2.

In an embodiment, the controller may set the data overrun threshold and the data underrun threshold to be 80% and 20% of the storage space of the audio signal buffer 140, respectively, but the invention is not limited thereto. The controller 120 may set different thresholds for different USB microphones and audio processing units, set the thresholds according to different operating frequencies (e.g. the writing frequency f1 and the reading frequency f2), and adjust the ratio of the data overrun threshold and the data underrun threshold in the storage space of the audio signal buffer 140. For example, the data overrun threshold and the data underrun threshold can be 75% and 25% of the storage space of the audio signal buffer 140, respectively.

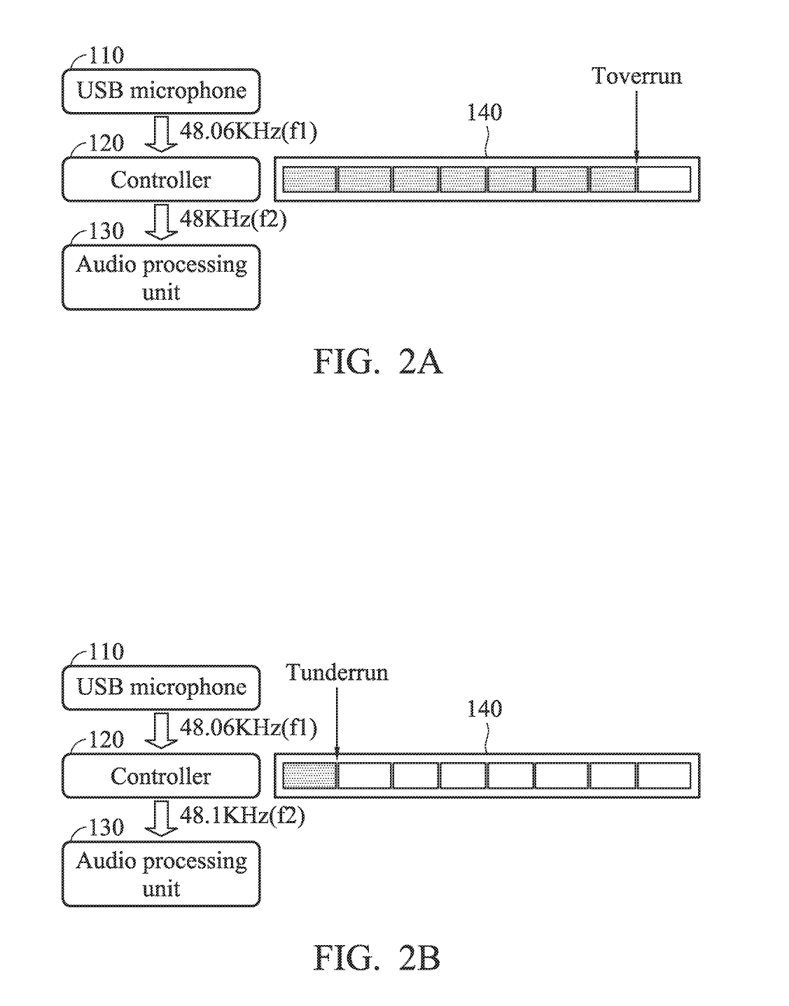

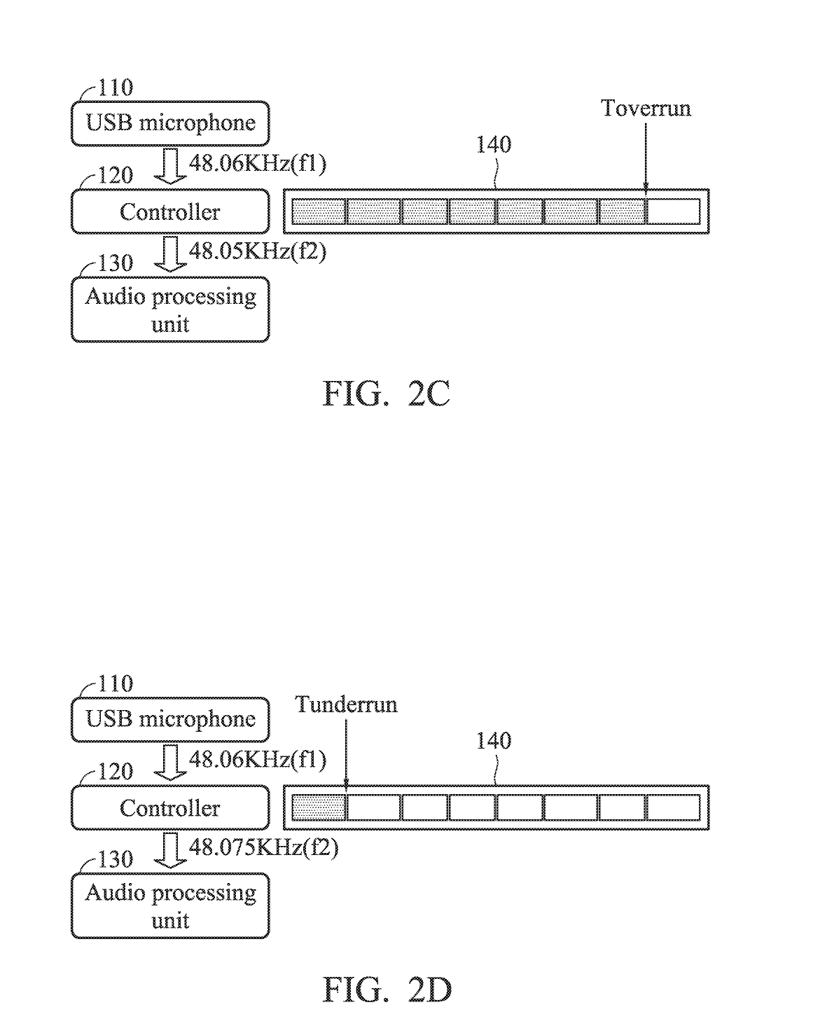

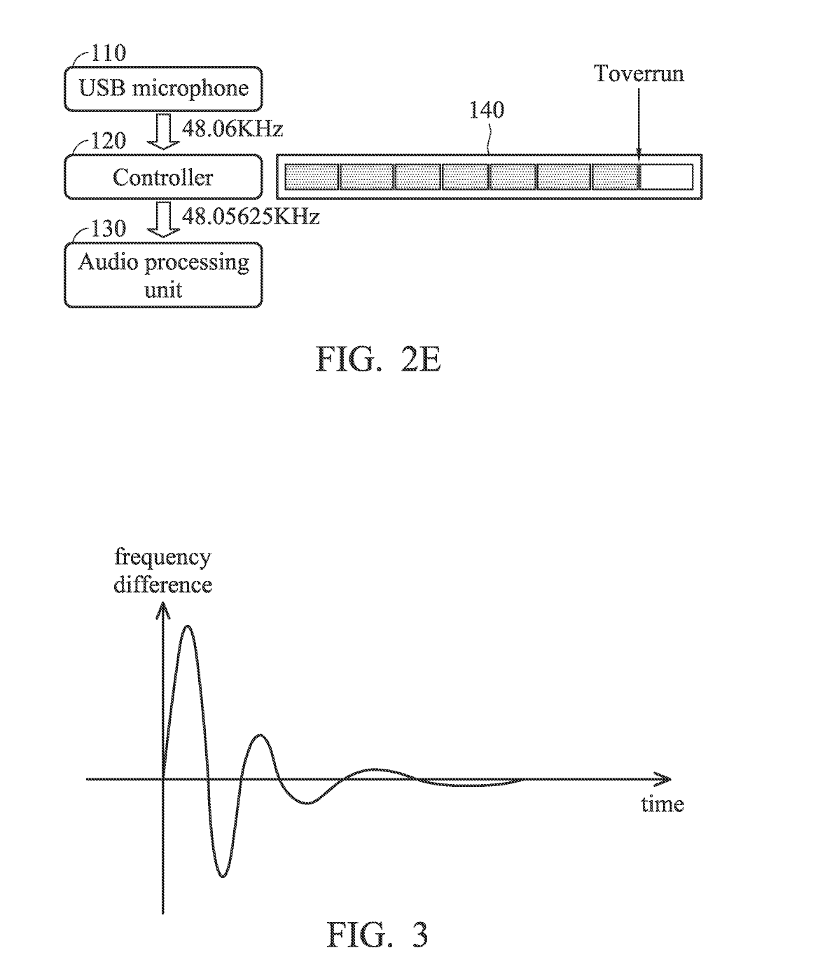

Referring to FIGS. 2A˜2E, FIGS. 2A˜2E illustrate the procedure of the storage condition of the audio signal buffer 140 according to an embodiment of the invention. As illustrated in FIG. 2A, the writing frequency f1 is not identical to the reading frequency f2 due to hardware limitations (e.g. the oscillator). For example, the writing frequency to write the audio signal A1 from the USB microphone 110 through the USB interface is 48.06 KHz (fixed and unchangeable), and the reading frequency f2 to read the audio signal A1 from the audio signal buffer 140 through the I2S interface is 48 KHz. Thereby, the writing frequency f1 is higher than the reading frequency f2. If there is no action to be taken, data overrun would happen in 1 second. Thus, the controller 120 of the application may increase the reading frequency f2 (e.g. 48.1 KHz) when the data stored in the audio signal buffer 140 reaches the data overrun threshold, so that the audio processing unit 130 may process the audio signal A1 with a frequency higher than writing frequency f1 to avoid data overrun.

Then, as illustrated in FIG. 2B, the writing frequency f1 would still be 48.06 Khz, and the reading frequency has been increased to 48.1 KHz. Meanwhile, the writing frequency f1 is lower than the reading frequency f2, but the difference between the writing frequency f1 and the reading frequency f2 becomes smaller. The amount of data stored in the audio signal buffer 140 may be reduced to reach the data underrun threshold in about 2 seconds. Then, the controller 120 may lower the reading frequency f2 of the audio processing unit f2, for example, to 48.05 KHz.

Subsequently, as illustrated in FIG. 2C, the writing frequency f1 is sustained at 48.06 KHz, but the reading frequency f2 is decreased to 48.05 KHz. Meanwhile, the writing frequency f1 is higher than the reading frequency f2, but the difference between the writing frequency f1 and the reading frequency f2 is further decreased. The amount of data stored in the audio signal buffer 140 may increase to reach the data overrun threshold in about 8 seconds. The controller 120 may increase the reading frequency f2 of the audio processing unit 130, for example, to 48.075 KHz.

As illustrated in FIG. 2D, the writing frequency f1 is sustained at 48.06 KHz, but the reading frequency is increased to 48.075 KHz. Meanwhile, the writing frequency f1 is lower than the reading frequency f2, but the difference between the writing frequency f1 and the reading frequency f2 is further decreased. The amount of data stored in the audio signal buffer 140 may decrease to reach the data underrun threshold in about 16 seconds. The controller 120 may lower the reading frequency f2, for example, to 48.0625 KHz.

As illustrated in FIG. 2E, the writing frequency f1 is sustained at 48.06 KHz, but the reading frequency f2 is decreased to 48.0625 KHz. Meanwhile, the writing frequency f1 is still lower than the reading frequency f2, but the difference between the writing frequency f1 and the reading frequency f2 is further decreased to 0.0025 KHz. Subsequently, the controller 120 may further lower the reading frequency f2 of the audio processing unit to 48.05625 KHz to “cross” the writing frequency f1, so that the reading frequency f2 is lower than the writing frequency f1. Although the writing frequency f1 is higher than the reading frequency f2, the difference between the writing frequency f1 and the reading frequency f2 is quite small. Thus, it may take a very long time (e.g. about 40 seconds) to decrease the amount of data stored in the audio signal buffer 140 to reach the data overrun threshold.

It should be noted that, the embodiments in FIGS. 2A˜2E describe the ways for adjusting the reading frequency f2 by the audio processing unit 130. When the writing frequency f1 is different from the reading frequency f2, the data stored in the audio signal buffer 140 may become either overrun or underrun after a period of time.

In another embodiment, the way for adjusting the reading frequency f2 of the audio processing unit 130 by the controller 120 may match a convergence curve, as illustrated in FIG. 3. That is, the controller 120 may dynamically adjust the reading frequency f2, so that the absolute difference between writing frequency f1 and reading frequency f2 may decrease gradually to converge. In other words, adjusting the reading frequency f2 by the controller 120 according to the convergence curve indicates that the reading frequency f2 is adjusted to approach the writing frequency f1. However, the difference between the writing frequency f1 and the reading frequency f2 is unknown from the start, and the writing frequency f1 is a fixed frequency (dependent on different USB microphones and unchangeable). Thus, the controller 120 may only determine the relationship between the writing frequency f1 and the reading frequency f2 according to the storage condition of the audio signal buffer 140.

In yet another embodiment, regarding the adjustment of the reading frequency f2 by the controller 120, if the adjusted reading frequency f2 “crosses” over the writing frequency, the frequency step (absolute difference) for a next adjustment is decreased (e.g. the absolute difference between the writing frequency f1 and the reading frequency f2 is halved) and the reading frequency f2 is reversely adjusted. That is, if the reading frequency f2 is higher than the writing frequency f1, the reading frequency f2 is decreased. Otherwise, the reading frequency f2 is increased, wherein the reading frequency after adjustment is f3. Specifically, “crossing over the writing frequency f1” indicates that the writing frequency f1 is between the reading frequency f2 (before the adjustment) and the reading frequency f3 (after the adjustment). If the writing frequency f1 is not between the reading frequency f2 and the reading frequency f3, the frequency step is further decreased for the next adjustment, and the reading frequency f2 is adjusted in the same direction (i.e. increment or decrement) until the reading frequency f3 crosses over the writing frequency f1 after the adjustment, as illustrated in FIG. 2E. Briefly, the controller 120 may adjust the reading frequency f2 according to a convergence curve dynamically to approach the writing frequency f1, as illustrated in FIG. 3.

In yet another embodiment, the controller 120 may multiply the reading frequency f2 of the I2S interface. For example, given that the operating frequency F_{c} of the controller 120 is 200 MHz, the operating frequency F_{c} can be multiplied by a multiplication number x, and the multiplication result is further divided by 1000 (not limited) to obtain the reading frequency f2 of the I2S interface. The frequency f2 can be expressed by the following formula:

$$\frac{{F}_{c} x}{1000} = f 2$$

The reading frequency f2 of the I2S interface can be further adjusted by changing the multiplying number x.

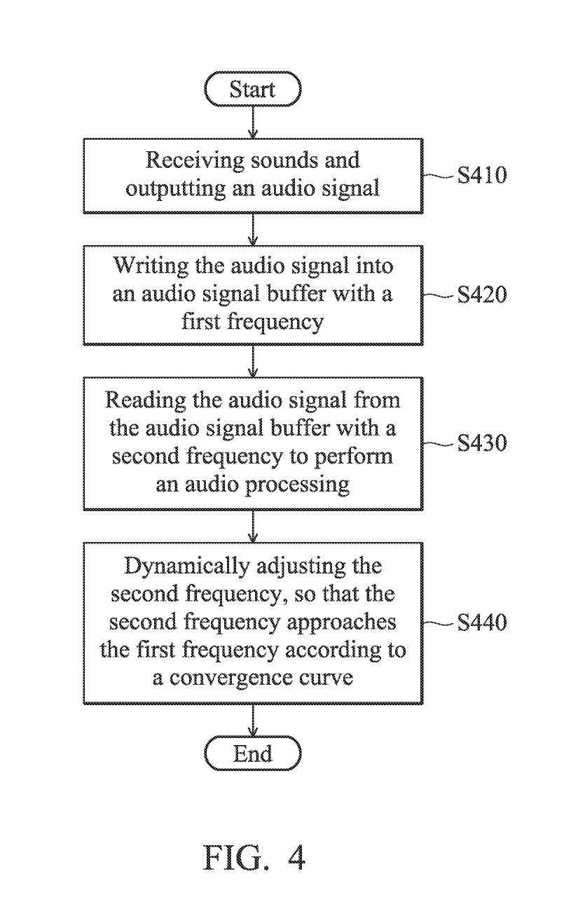

FIG. 4 illustrates a flow chart of the adjusting method of the audio signal buffer according to an embodiment of the invention. In step S410, the USB microphone 110 may capture sounds and output an audio signal A1. In step S420, the controller 120 may write the audio signal A1 to the audio signal buffer 140 with a first frequency (e.g. the writing frequency f1). In step S430, the audio processing unit 130 may read the audio signal A1 from the audio signal buffer 140 with a second frequency (e.g. the reading frequency f2) to perform an audio processing. In step S440, the controller 120 may dynamically adjust the second frequency, so that the second frequency may approach the first frequency according to a convergence curve. As described in the aforementioned embodiments, the convergence curve may indicate that the difference between the second frequency and the first frequency may decrease gradually to avoid data overrun or data underrun of the audio signal buffer 140 from occurring.

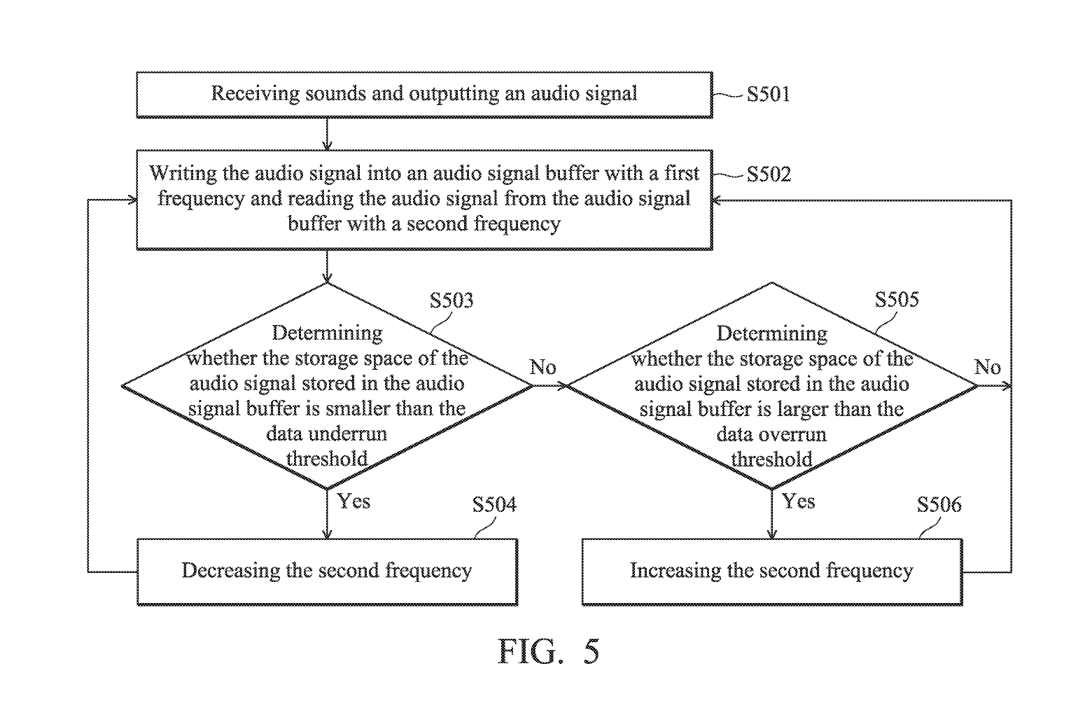

FIG. 5 illustrates a flow chart of the adjusting method of the audio signal buffer according to another embodiment of the invention, wherein FIG. 5 further describes the details of the steps in FIG. 4. In step S501, the USB microphone 110 may receive sounds and output an audio signal A1. In step S502, the USB microphone 110 may transmit the audio signal A1 to the audio processing unit 130 through the controller 120. Specifically, the USB microphone may write the audio signal A1 to the audio signal buffer 140 of the controller 120 with a writing frequency f1 through the USB interface. In addition, the controller 120 may control the I2S interface to read the audio signal A1 from the audio signal buffer 140 to the audio processing unit 130 with a reading frequency f2. In step S503, the controller 120 may determine whether the storage space of the audio signal A1 stored in the audio signal buffer 140 has exceeded the data overrun threshold. If so, step S506 is performed. Otherwise, step S502 is performed. In step S506, the controller 120 may increase the reading frequency f2 of the I2S interface, and go back to step S502.

It should be noted that when the audio processing system 100 performs the steps in FIG. 5, the USB microphone 100 may consistently store the audio signal A1 to the audio signal buffer 140 through the USB interface, and the audio processing unit 130 may consistently read the audio signal A1 from the audio signal buffer 140 through the I2S interface (step S502). If the adjusted reading frequency f2 does not cross over the writing frequency f1 as described in aforementioned embodiments, step S502 is performed. However, the frequency step is further decreased. That is, the audio signal A1 is consistently transmitted from the USB microphone 110 to the audio processing unit 130 through the controller 120. After step S502 is performed, the controller 120 may further determine whether the storage space of the audio signal stored in the audio signal buffer 140 has exceeded the data overrun threshold or the data underrun threshold. Further, the order of the steps S503 and S505 can be adjusted.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An audio processing system, comprising
a sound receiving device configured to receive sounds and output an audio signal;
a controller, electrically connected to the sound receiving unit, and configured to write the audio signal to an audio signal buffer with a first frequency; and
an audio processing unit, electrically connected to the controller, and configured to read the audio signal from the audio signal buffer with a second frequency to perform an audio processing,
wherein the controller further dynamically adjusts the second frequency, so that the second frequency approaches the first frequency according to a convergence curve.

2. The audio processing system as claimed in claim 1, wherein the controller is coupled to the sound receiving device through a first transmission interface, and the audio processing unit is coupled to the controller through a second transmission interface.

3. The audio processing system as claimed in claim 2, wherein the first transmission interface is a USB interface, and the second transmission interface is an I2S interface.

4. The audio processing system as claimed in claim 1, wherein the controller further sets a data overrun threshold and a data underrun threshold according to a storage space of the audio signal stored in the audio signal buffer.

5. The audio processing system as claimed in claim 4, wherein the controller further determines whether the storage space of the audio signal stored in the audio signal buffer is smaller than the data underrun threshold, and when the storage space of the audio signal stored in the audio signal buffer is smaller than the data underrun threshold, the controller further decreases the second frequency by a first frequency step to generate a third frequency.

6. The audio processing system as claimed in claim 5, wherein the first frequency step is half of an absolute difference between the first frequency and the second frequency.

7. The audio processing system as claimed in claim 4, wherein the controller further determines whether the storage space of the audio signal stored in the audio signal buffer is larger than the data underrun threshold, and when the storage space of the audio signal stored in the audio signal buffer is larger than the data underrun threshold, the controller further increases the second frequency by a second frequency step to generate a fourth frequency.

8. The audio processing system as claimed in claim 7, wherein the second frequency step is a half of an absolute difference between the first frequency and the second frequency.

9. An adjusting method for an audio signal buffer, comprising:
receiving sounds and outputting an audio signal;
writing the audio signal to the audio signal buffer with a first frequency;
reading the audio signal from the audio signal buffer with a second frequency; and
dynamically adjusting the second frequency, so that the second frequency approaches the first frequency according to a convergence curve.

10. The method as claimed in claim 9, wherein the audio signal is written to the audio signal buffer through a USB interface, and the audio signal is read from audio signal buffer through an 12S interface.

11. The method as claimed in claim 9, further comprising:
setting a data overrun threshold and a data underrun threshold according a storage space of the audio signal stored in the audio signal buffer.

12. The method as claimed in claim 11, wherein the step of dynamically adjusting the second frequency further comprises:
determining whether the storage space of the audio signal stored in the audio signal buffer is smaller than the data underrun threshold;
when the storage space of the audio signal stored in the audio signal buffer is smaller than the data underrun threshold, decreasing the second frequency by a first frequency step to generate a third frequency; and
reading the audio signal with the third frequency.

13. The method as claimed in claim 12, wherein the step of dynamically adjusting the second frequency further comprises:
determining whether the storage space of the audio signal stored in the audio signal buffer is larger than the data overrun threshold;
when the storage space of the audio signal stored in the audio signal buffer is smaller than the data overrun threshold, increasing the second frequency by a second frequency step to generate a fourth frequency; and
reading the audio signal with the fourth frequency.

14. The method as claimed in claim 13, wherein the first frequency step is a half of an absolute difference between the first frequency and the second frequency, and the second frequency step is a half of an absolute difference between the first
